(19) United States
(12) Patent Application Publication
(10) Pub. No.: US 2017/0103417 A1
(43) Pub. Date: Apr. 13, 2017

(54) CARDINALITY ESTIMATION OF AUDIENCE SEGMENTS

(71) Applicant: Adobe Systems Incorporated, San Jose, CA (US)

(72) Inventors: Trung Thanh Nguyen, San Jose, CA (US); Shashank Ramaprasad, San Francisco, CA (US)

(21) Appl. No.: 14/877,666

(22) Filed: Oct. 7, 2015

(51) Int. Cl. G06Q 30/02; G06F 17/30

(52) U.S. Cl. CPC G06Q 30/0254; G06F 17/30477

(57) ABSTRACT

The cardinality of an audience logical expression is estimated in real time based on Hyperloglog data structures. In embodiments, an apparatus includes a communication module to receive a query for cardinality estimation associated with an audience logical expression. Further, the apparatus includes a conversion module to convert the audience logical expression into an equivalent expression based on selected Hyperloglog data structures, and an estimation module estimates the cardinality associated with the audience logical expression based on one or more addition or subtraction operations with the respective cardinality associated with the selected Hyperloglog data structures.

### BACKGROUND

Digital marketing includes the targeted, measurable, and interactive marketing of products or services using digital technologies to reach and convert leads into customers. Digital marketing may promote brands, build preference, and increase sales through various digital marketing techniques. One important aspect of a digital marketing campaign is identifying individuals to target with marketing messages. Often, digital marketers try to target a particular audience segment, which is a set of individuals who have performed and/or not performed an action that is of relevance to the marketers. In order to identify such audience segments, marketers frequently construct “audience logical expressions” (ALEs), which are arbitrary Boolean logical expressions over existing audience segments.

As an example, consider the following ALE: “people who visited the newest phone page in the last 7 days but did not convert.” This ALE is equivalent to the Boolean expression of “A AND ˜B”, where A and B are audience segments representing the set of people who visited the new phone page in the last 7 days and the set of people who bought the new phone, respectively. For the purpose of budgeting or planning in digital marketing, marketers would like to know, in real time, and to a reasonable degree of accuracy, the cardinality of such ALEs.

Prior attempts for cardinality estimation of such ALEs generally suffer from one or more of the following problems: inaccurate estimation, no real-time response, or requiring prohibitive amounts of storage and computation. Thus, existing approaches may be impractical to digital marketing in many cases.

### BRIEF DESCRIPTION OF THE DRAWINGS

Embodiments will be readily understood by reading the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a schematic diagram illustrating an example implementation of an apparatus for estimating cardinality, incorporating aspects of the present disclosure, in accordance with various embodiments.

FIG. 2 is a flow diagram of an example process for estimating cardinality, which may be practiced by an example apparatus, incorporating aspects of the present disclosure, in accordance with various embodiments.

FIG. 3 is a flow diagram of an example process for identifying HLLs for a Boolean expression, which may be practiced by an example apparatus, incorporating aspects of the present disclosure, in accordance with various embodiments.

FIG. 4 illustrates an example computing device suitable for practicing the disclosed embodiments, in accordance with various embodiments.

FIG. 5 illustrates an article of manufacture having programming instructions, incorporating aspects of the present disclosure, in accordance with various embodiments.

### DETAILED DESCRIPTION

Various terms are used throughout this description. Although more details regarding various terms are provided throughout this description, general definitions of some terms are included below to provider a clearer understanding of the ideas disclosed herein.

In various embodiments, for the purposes of the present disclosure, the phrase “audience” means a group of people or entities that used in commercial marketing, and “audience segment” means a set of elements (e.g., individuals) who have performed and/or not performed an action that is of relevance to marketing. For example, the audience in Seattle (or consumers used for marketing in Seattle) may be divided into audience segments (or subgroups) based upon defined criterion, such as product usage, demographics, etc. By way of example, consumers in Seattle who drink coffee everyday form an audience segment. Similarly, the rest of consumers in Seattle who do not drink coffee also forms an audience segment.

The “cardinality” of a set means the number of elements of the set. Since a set is a collection of distinct objects, the cardinality of a set thus also means the distinct number of elements of the set. By way of example, the set of citrus fruits {lemon, lime, orange, grapefruit} contains 4 elements, and therefore this set has a cardinality of 4. Accordingly, the cardinality of an audience segment means the distinct number of elements in an audience segment. For instance, an online store received 1000 distinct orders in a particular day, which include 200 orders for computers, 300 orders for phones, and 500 orders for accessories. In this case, the cardinality of the computer related audience segment is 200. Similarly, the cardinality of the phone related audience segment is 300, and the cardinality of the accessory related audience segment is 500.

“Audience logical expression” or “ALE” means any arbitrary Boolean logical expressions over existing audience segments. By way of example, a Boolean expression relating two or more audience segments with Boolean operators, e.g., AND, OR, NOT, etc., is an ALE. Therefore, the cardinality associated with an ALE refers to the number of elements in the ALE. As an example, the ALE of “people who purchased a new phone last week but did not purchase a data plan” is equivalent to the Boolean expression of “A AND ˜B”, where A and B are audience segments representing the set of people who purchased a new phone last week and the set of people who did not purchase a data plan, respectively. For the purpose of budgeting or planning in digital marketing, marketers would like to know with a reasonable degree of accuracy the cardinality of such ALEs.

“HyperLogLog” or “HLL” refers to an algorithm and related data structures for approximating the number of distinct elements in a multiset. Generally, computing the precise cardinality of a multiset requires an amount of memory proportional to the cardinality, which may be impractical for very large data sets. HLL can be used as a probabilistic cardinality estimator, which obtains a good estimation of the distinct elements in a multiset, but uses much less memory. Existing HLL framework can readily provide the cardinality of an HLL data structure or perform expedite union operations over HLL data structures. However, existing HLL framework does not have native functions to support Boolean operations over HLL data structures.

A “component” of an expression is a part of the expression. In various embodiments, the cardinality of an ALE can be converted into an equivalent expression with one or more components linked by addition or subtraction operators, wherein each component is represented by an HLL or a union of HLLs. As an example, the ALE of “people who purchased a new phone last week AND also purchased a data plan for the new phone” is equivalent to the Boolean expression of “A AND B”, where A and B are audience segments representing the set of people who purchased a new phone last week and the set of people who also purchased a data plan for the new phone, respectively. The cardinality of this ALE can be converted into an equivalent expression with three components as |A|+|B|−|A OR B|, wherein “A” can be represented by an HLL, “B” can also be represented by an HLL, and “A OR B” can be represented by a union of two HLLs for A and B.

Embodiments of the present invention are directed to improving query performance on cardinality estimation of ALEs. In this regard, an ALE uses multiple Boolean operators to relate multiple audience segments. In various embodiments, a user submits a query to a server for a cardinality of an ALE (i.e., to determine the number of individuals in a new audience segment formed from a relation of audience segments). The server converts the ALE into an equivalent expression with one or more Hyperloglog (HLL) data structures based on HLL technology and some properties of Boolean algebra. In this equivalent expression, each component is represented by an HLL or a union of HLLs. When the HLL-based equivalent expression contains only individual HLLs or unions of HLLs, it becomes fairly efficient to obtain the respective cardinalities of these HLLs, and subsequently to calculate the overall cardinality for the ALE. More specifically, and by way of example only, retrieving respective cardinalities associated with these HLLs can be supported by native functions in Hyperloglog technology. Therefore, the cardinality of the ALE is obtained based on one or more addition or subtraction operations with the respective cardinalities retrieved from these HLLs.

This disclosure addresses the problem of real-time cardinality estimation, e.g., for ALEs. As discussed previously, an audience segment is a set of individuals who have performed an action and/or not performed an action that is of relevance to the marketer, e.g., in digital marketing. Marketers frequently construct arbitrary ALEs, e.g., in analyzing the market or to discover new audiences. However, present approaches for cardinality estimation of such ALEs generally are not very accurate, cannot offer a real-time response, and/or require prohibitive amounts of storage and computation.

Hyperloglog is a state-of-the-art technique for efficiently estimating cardinality. Hyperloglog uses probabilistic cardinality estimation algorithms, which use significantly less memory at the cost of obtaining only an approximation of the cardinality, albeit, a reasonably accurate one. However, the cardinality of an ALE, e.g., including various Boolean operators, generally cannot be obtained directly from HLL.

Embodiments of the present invention exploit the structure of HLL and utilize some properties of Boolean algebra to estimate the cardinality of a large class of ALEs. As a result, the cardinality of an ALE is estimated in real time based on HLL data structures. Such estimation can be performed in real time with substantial accuracy and requires only minimal storage and modest computing power.

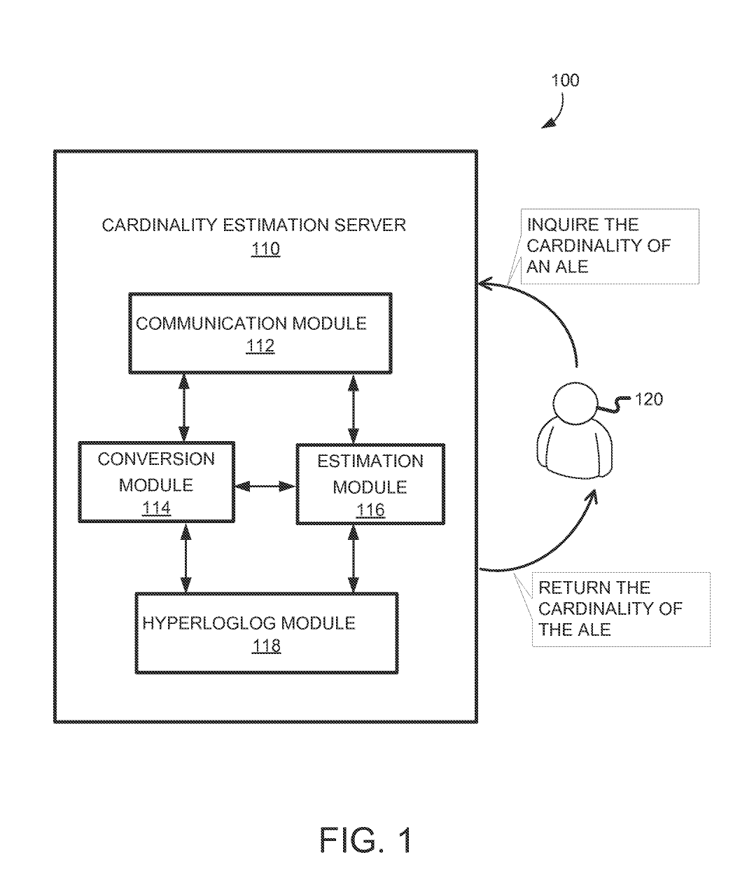

In one embodiment, an apparatus includes a communication module to receive a query for cardinality estimation associated with an ALE. Further, the apparatus has a conversion module to convert the ALE into HLL data structures, and an estimation module to estimate the cardinality associated with the ALE based on one or more addition or subtraction operations with respective cardinalities associated with these HLLs. These and other aspects of the present disclosure will be more fully described below in connection with FIGS. 1-5.

With reference now to FIG. 1, an example implementation of system 100 for estimating cardinality, in accordance with various embodiments, is illustrated. In various embodiments, cardinality estimation server 110 may be a server computing device, which is configured to exploit the structure of HLL and some properties of Boolean algebra to estimate the cardinality for a large class of ALEs, e.g., by marketers. In various embodiments, cardinality estimation server 110 may use communication module 112, conversion module 114, estimation module 116, and Hyperloglog module 118, operatively coupled with each other, to perform cardinality estimation, e.g., in real time for an ALE.

User 120 can submit a query for the cardinality of an ALE to cardinality estimation server 110, subsequently, to receive the response from cardinality estimation server 110. In various embodiments, communication module 112 can enable cardinality estimation server 110 to communicate with another computing device (e.g., used by user 120), to receive the query for cardinality estimation and/or to provide the result of cardinality estimation afterwards, by utilizing one or more wireless or wired networks. The networks may include public and/or private networks, such as, but not limited to, the Internet, a telephone network (e.g., public switched telephone network (PSTN)), a local area network (LAN), a wide area network (WAN), a cable network, an Ethernet network, and so forth. In various embodiments, cardinality estimation server 110 is to be coupled to these networks via a cellular network and/or a wireless connection. Wireless communication networks may include various combinations of wireless personal area networks (WPANs), wireless local area networks (WLANs), wireless metropolitan area networks (WMANs), and/or wireless wide area networks (WWANs). Cellular networks may include, for example, Wideband Code Division Multiple Access (WCDMA), Global System for Mobile Communications (GSM), Long Term Evolution (LTE), and the like.

In one embodiment, cardinality estimation server 110 receives a query for estimating the cardinality of an ALE with one or more Boolean operators. In various embodiments, conversion module 114 may convert the ALE to its equivalent expression with one or more components, such that each component is to be represented by an HLL data structure or a union of HLL data structures. In some embodiments, a user can manually relate several audience segments with selected Boolean operators, such as AND, OR, NOT, etc. Thus, conversion module 114 may need to break the ALE into multiple terms, e.g., based on these selected Boolean operators. In some embodiments, a user inputs the ALE in natural language. In this case, conversion module 114 employs natural language processing (NLP) techniques to determine the semantics of the ALE, such as audience segments in the ALE and how they ought to be connected to each other, e.g., use conjunction or disjunction.

In some embodiments, communication module 112 receives the ALE having audience segments for a given time period with at least one selected operator from conjunction, disjunction, and negation. In many cases, marketers may be interested in audience segments for a given time period to track or measure the efficacy of an advertising campaign. As illustrated in the following example, the ALE of “people who visited the website last week from Canada OR from Mexico” is equivalent to the Boolean expression of “A OR B,” where A and B are audience segments respectively representing the set of people who visited the website last week from Canada and the set of people who visited the website last week from Mexico, respectively. In this case, to identify HLL-based equivalent expression for this ALE including a disjunctive operator, conversion module 114 can rely on set unions in HLL because set unions in HLL are composable and lossless. Thus, conversion module 114 can identify the HLL for A and the HLL for B, then call a set union of A and B, largely relying on the native capability of HLL. In various embodiments, disjunctive expressions like “A OR B OR C OR . . . ,” where A, B, C, etc., are basic audience segments for which there is a corresponding HLL, may be converted in similar fashions to a set union of all corresponding HLLs. In this case, conversion module 114 may only need to identify the union of all corresponding HLLs.

In some embodiments, cardinality estimation server 110 may receive a query for estimating the cardinality of an ALE with a conjunctive operator. As illustrated in the following example, the ALE of “people who received the promotion code last week AND used the promotion code” is equivalent to the Boolean expression of “A AND B,” where A and B are audience segments respectively representing the set of people who received the promotion code last week and the set of people who actually used the promotion code last week. To identify an HLL-based equivalent expression for this ALE including a conjunction operator, conversion module 114 uses the inclusion-exclusion principle. For instance, the cardinality of “A AND B” can be converted to the summation of the respective cardinalities of A and B, then subtracted by the cardinality of the union of A and B, as illustrated in Eq. 1. In this case, conversion module 114 needs to identify three HLLs, namely, the HLL for A, the HLL for B, and the union of A and B.

|A AND B|=|A|+|B|−|A OR B| Eq. 1.

It may be noted that conjunction can lead to reduced accuracy in the cardinality estimation. In particular, to achieve reasonable accuracy, the cardinalities of A and B may not differ by more than two orders of magnitude, and there should be some overlap in common elements of A and B.

In some embodiments, cardinality estimation server 110 receives a query for estimating the cardinality of an ALE including the intersection of two disjunctive expressions, e.g., ((A1 OR A2) AND (A3 OR A4)). To identify an HLL-based equivalent expression for this ALE including the intersection of two disjunctive expressions, conversion module 114 may first identify the union of corresponding HLLs of A1 and A2, and the union of corresponding HLLs of A3 and A4, then follow the principle identified above in connection with the conjunction operator.

In some embodiments, cardinality estimation server 110 receives a query for estimating the cardinality of an ALE including a negation operator. As an example, the ALE of “customers who use phones that are incompatible with 4G standards” is equivalent to the Boolean expression of “˜A,” where A is the audience segment representing the set of people who use phones that are compatible with 4G standards. To identify an HLL-based equivalent expression for this ALE including a negation operator, conversion module 114 may have to know the cardinality of all the other audience segments in the same category. For instance, the cardinality of “˜A” may be converted to the cardinality of the union of all audience segments in the same category subtracted by the cardinality of the negated audience segment, as illustrated in Eq. 2, assuming there are only three simplified audience segments in the same category. In this case, conversion module 114 may have to identify the union of all relevant HLLs and the HLL for A.

$$\begin{matrix}\vert \sim A \vert = \vert B OR C \vert - \vert A AND ( B OR C ) \vert \\ = \vert B OR C \vert - ( \vert A \vert + \vert B OR C \vert - \vert A OR B OR C \vert ) \\ = \vert A OR B OR C \vert - \vert A \vert\end{matrix} \qquad Eq . 2$$

In some embodiments, cardinality estimation server 110 receives a query for estimating the cardinality of an ALE including negations of disjunctive expressions, such as the ALE of “people who are not using smartphones manufactured by Apple, Samsung, and Nokia.” This example ALE is equivalent to the Boolean expression of ˜(A1 OR A2 OR A3) where A1, A2, and A3 represent audience segments of the set of people who use smartphones that are manufactured by Apple, Samsung, and Nokia, respectively. To identify an HLL-based equivalent expression for this ALE including a negation of a plurality of disjunctive expressions, conversion module 114 may first identify the union of corresponding HLLs of A1, A2, and A3, then follow the principle identified above in connection with the negation operator.

In some embodiments, cardinality estimation server 110 receives a query for estimating the cardinality of an ALE including the intersection of two disjunctive expressions where exactly one of them is a negation, e.g., ((A1 OR A2) AND ˜(A2 OR A3)). To identify an HLL-based equivalent expression for this type of ALE, conversion module 114 can first identify the union of corresponding HLLs of A1 and A2 as well as the union of corresponding HLLs of A2 and A3, then follow the principle identified above in connection with the negation operator and the conjunction operator.

Estimation module 116, coupled to communication module 112 and conversion module 114, estimates respective cardinality associated with respective HLLs or unions of HLLs identified by conversion module 114. Further, estimation module 116 determines the cardinality associated with the ALE based on its equivalent expression identified by conversion module 114, which may include one or more addition or subtraction operations with the respective cardinality associated with these respective HLLs or unions of HLLs. In various embodiments, as the HLL-based equivalent expression of the ALE contains only individual HLLs or unions of HLLs, estimation module 116 can utilize the native capabilities of HLL to obtain their respective cardinalities rather quickly.

As a result, cardinality estimation server 110 is able to do cardinality estimations instantaneously for logical expressions involving up to hundreds of audience segments generally within a standard error of 2%. On the other hand, in one experiment, storing 100 days' worth of HLLs for over 2,000 segments with an average cardinality of 15,000 (with the maximum up to 1.7 million) takes up only 245 MB of memory. Thus, cardinality estimation server 110 may only need very modest memory to conduct cardinality estimations in real time.

In various embodiments, Hyperloglog module 118 facilitates conversion module 114 and estimation module 116 to build, store, retrieve, query, or otherwise access and manipulate corresponding HLLs for cardinality estimations. In some embodiments, Hyperloglog module 118 may include a query engine to a data server, e.g., remote to cardinality estimation server 110, that houses all HLLs discussed herein.

In various embodiments, cardinality estimation server 110 may be implemented differently than depicted in FIG. 1. As an example, conversion module 114 may be combined with estimation module 116 to form a comprehensive module for cardinality estimations. In some embodiments, components depicted in FIG. 1 may have a direct or indirect connection not shown in FIG. 1. In some embodiments, some of the components depicted in FIG. 1 may be divided into multiple modules, with each module to perform more specific functions.

In various embodiments, one or more components of cardinality estimation server 110 may be located across any number of different devices or networks. As an example, Hyperloglog module 118 may be implemented as an integrated subsystem of a data server rather than located in cardinality estimation server 110.

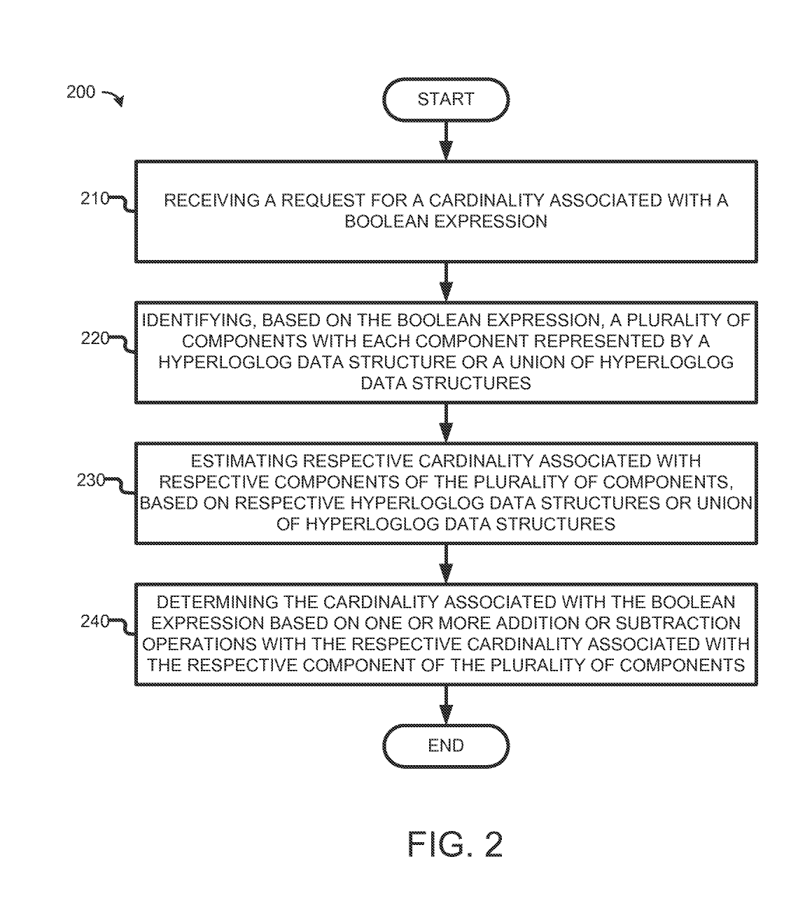

Referring now to FIG. 2, it is a flow diagram of an example process 200 for estimating cardinality, which may be practiced by an example apparatus in accordance with various embodiments. Process 200 may be performed by processing logic that comprises hardware (e.g., circuitry, dedicated logic, programmable logic, microcode, etc.), software (e.g., instructions run on a processing device to perform hardware simulation), or a combination thereof. The processing logic may be configured for cardinality estimations. As such, process 200 is to be performed by a computing device, e.g., cardinality estimation server 110, to implement one or more embodiments of the present disclosure. In various embodiments, process 200 may have fewer or additional operations, or perform some of the operations in different orders.

A process to estimate cardinality, in one embodiment, may start by converting the receiving ALE to an HLL-based equivalent expression. When the HLL-based equivalent expression contains only individual HLLs or unions of HLLs, it becomes fairly efficient to obtain their respective cardinalities, and subsequently to calculate the overall cardinality for the receiving ALE.

In various embodiments, process 200 may begin at block 210, where a computing device, e.g., cardinality estimation server 110 of FIG. 1, receives a request for a cardinality associated with a Boolean expression. As an example, cardinality estimation server 110 of FIG. 1 receives a query for the ALE of “customers who use smartphones AND who also subscribe to high-speed mobile data plans (HSMDPs).” This ALE is equivalent to the Boolean expression of “A AND B,” where A and B are audience segments respectively representing the set of customers using smartphones and the set of customers subscribed to HSMDPs.

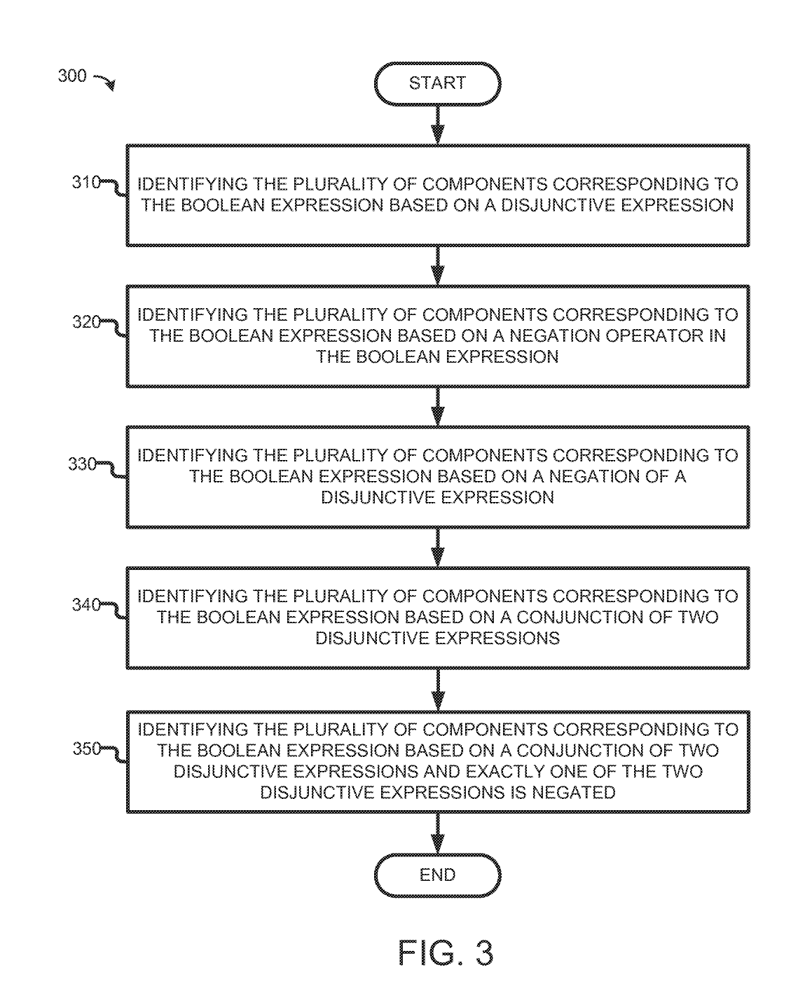

At block 220, cardinality estimation server 110 identifies, based on the Boolean expression, a plurality of components with each component represented by an HLL or a union of HLLs. To identify an HLL-based equivalent expression for this ALE including a conjunction operator, cardinality estimation server 110 can use the inclusion-exclusion principle. For instance, the cardinality of “A AND B” can be converted to the summation of the respective cardinalities of A and B, and subtracted by the cardinality of the union of A and B, as illustrated in Eq. 1. In this case, cardinality estimation server 110 needs to identify three HLLs, namely, the HLL for “customers using smartphones,” the HLL for “customers subscribed to HSMDPs,” and the union of these two HLLs. These and other aspects of the present disclosure related to identifying the HLL-based equivalent expression and respective HLLs will be more fully described below, e.g., in connection with FIG. 3.

At block 230, cardinality estimation server 110 estimates respective cardinality associated with respective components of the plurality of components, based on respective HLLs or union of HLLs. In various embodiments, after cardinality estimation server 110 converts an ALE to its HLL-based equivalent expression that contains only individual HLLs or unions of HLLs, it becomes fairly efficient to obtain their respective cardinalities because Hyperloglog may provide time and memory efficient cardinality estimations for HLLs, and Hyperloglog also has lossless native support for the union operator without sacrificing precision or accuracy.

At block 240, cardinality estimation server 110 determines the cardinality associated with the Boolean expression based on one or more addition or subtraction operations with the respective cardinality associated with the respective component of the plurality of components. In various embodiments, the HLL-based equivalent expression of the ALE may contain one or more addition or subtraction operations on corresponding HLLs. In reference to Eq. 1, the Boolean expression of “A AND B” contains one addition and one subtraction. Thus, the cardinality associated with the ALE can be obtained once the cardinalities of respective HLLs are known. In various embodiments, the final result of the cardinality of the ALE is to be presented to the requesting user to assist the user in making appropriate decisions, e.g., to budget an advertising campaign.

Referring now to FIG. 3, it is a flow diagram of an example process 300 for identifying HLLs for a Boolean expression, which may be practiced by an example apparatus in accordance with various embodiments. As shown, process 300 is to be performed by cardinality estimation server 110 of FIG. 1 to implement one or more embodiments of the present disclosure. In some embodiments, process 300 is to be performed in reference to block 220 in FIG. 2. In various embodiments, various blocks in FIG. 3 may be combined or arranged in any suitable order, e.g., according to the particular embodiment of cardinality estimation server 110 for cardinality estimation.

An ALE may include various Boolean operators. As an example, a disjunctive ALE expression is a logical expression that involves only disjunctions, or set unions, of audience segments. In various embodiments, cardinality estimation server 110 identifies HLLs to build an equivalent expression for the ALE based on its specific Boolean operators. In various embodiments, given the universe of sets A1, A2, A3, etc., cardinality estimation server 110 is able to compute cardinalities for various types of ALEs, such as disjunctive expressions, e.g., A1 OR A2 OR A3; such as negations of disjunctive expressions, e.g., ˜(A1 OR A2 OR A3); such as intersection of two disjunctive expressions, e.g., ((A1 OR A2) AND (A2 OR A3)); such as intersection of two disjunctive expressions where exactly one of them is a negation, e.g., ((A1 OR A2) AND ˜(A2 OR A3)); and so on.

At block 310, cardinality estimation server 110 identifies the corresponding HLLs for a Boolean expression including a disjunctive expression, such as A1 OR A2 OR A3. As an example, an online grocery store for home delivery may be interested in expanding its customer base in Seattle. The online grocery store may want to explore potential new customers “who are young professionals working in Seattle OR who have shopped online at least once per month OR who have the Prime Membership of Amazon,” which is equivalent to the Boolean expression of “A1 OR A2 OR A3,” where A1, A2, and A3 are audience segments respectively representing the set of people “who are young professionals working in Seattle,” “who have shopped online at least once per month,” and “who have the Prime Membership of Amazon.” In this case, to identify an HLL-based equivalent expression for this ALE including two disjunctive operators, cardinality estimation server 110 needs to identify the corresponding HLLs, e.g., via Hyperloglog module 118 of FIG. 1, for A1, A2, and A3, then identify the union of A1, A2, and A3, which is natively supported as composable and lossless operations in HLL.

At block 320, cardinality estimation server 110 identifies the corresponding HLLs for a Boolean expression based on a negation operator in the Boolean expression. Negation is special in that it may require knowing the cardinality of all the other segments in a selected class. As discussed in connection with Eq. 2 herein, |˜A1|=|A1 OR A2 OR A3|−|A1|, wherein A1, A2, and A3 form the complete relevant class. As an example, the ALE of “customers who did not buy deal X from website Y” is equivalent to the Boolean expression of “˜A1” in reference to customers from website Y, where A1 is the audience segment representing the set of customers who bought deal X from website Y.

To identify the corresponding HLLs for this ALE including a negation operator, all the audience segments in the same class may need to be identified. For instance, the cardinality of “˜A1” can be converted to the cardinality of the union of all audience segments in the same category subtracted by the cardinality of the negated audience segment, as illustrated in Eq. 2. Assuming A1, A2, and A3 form the universe of audience segments for the customers of website Y, in this case, cardinality estimation server 110 is to identify the HLL for A1, A2, and A3, as well as the union of A1, A2, and A3, so that the cardinality of “˜A1” can be ascertained. It should be noted that negation may not be composable in some embodiments; thus, cardinality estimation server 110 may not able to compute cardinality for an arbitrary ALE with negation operators.

At block 330, cardinality estimation server 110 identifies the corresponding HLLs for a Boolean expression based on a negation of a disjunctive expression, such as “˜(A1 OR A2 OR A3).” In view of block 310 and block 320, to identify the corresponding HLLs for the ALE in the form of “˜(A1 OR A2 OR A3),” the union of A1, A2, and A3 can be obtained after identifying the corresponding HLLs for A1, A2, and A3, respectively. Subsequently, the class associated with the union of A1, A2, and A3 can be identified, so that all other members in this class can also be discovered. Finally, the union of all members in the HLL for this class can be obtained, which leads the cardinality of the original ALE, based on the principles disclosed in block 310 and block 320 herein.

At block 340, cardinality estimation server 110 identifies the corresponding HLLs for a Boolean expression based on a conjunction of two disjunctive expressions, e.g., ((A1 OR A2) AND (A2 OR A3)). In some embodiments, a disjunctive expression only contains one audience segment; thus, this group of ALEs may be manifested in a form, e.g., as (A1 AND A2). In other embodiments, a disjunctive expression may contain a union of many terms.

To identify the corresponding HLLs for the ALE in the form of “((A1 OR A2) AND (A3 OR A4)),” one can first identify the corresponding HLLs for A1, A2, A3, and A4, respectively, so that the union of A1 and A2 as well as the union of A3 and A4 can be obtained. Subsequently, the conjunction of these two unions can be performed based on the inclusion-exclusion principle, such as |(A1 OR A2) AND (A3 OR A4)|=|A1 OR A2|+|A3 OR A4|−|A1 OR A2 OR A3 OR A4|. It may be noted that conjunction is not fully composable with HLLs. Thus, it may be impossible to use the HLL estimate to compute the cardinality for an arbitrary ALE involving more than one conjunction, e.g., A1 AND A2 AND A3, in some situations.

At block 350, cardinality estimation server 110 identifies the corresponding HLLs for a Boolean expression based on a conjunction of two disjunctive expressions and exactly one of the two disjunctive expressions is negated, e.g., ((A1 OR A2) AND ˜(A2 OR A3)). To identify the corresponding HLLs for the ALE in such form, a Venn diagram is used as the basis to transform the expression. From a Venn diagram, it can be recognized that |A AND ˜B|=|A OR B|−|B|. Therefore, the expression of |(A1 OR A2) AND ˜(A2 OR A3)| may be transformed to |A1 OR A2 OR A3|−|A2 OR A3| according to Eq. 3.

$$\vert ( A 1 OR A 2 ) AND \sim ( A 2 OR A 3 ) \vert = \vert ( A 1 OR A 2 ) OR ( A 2 OR A 3 ) \vert - \vert A 2 OR A 3 \vert = \vert A 1 OR A 2 OR A3 \vert - \vert A 2 OR A 3 \vert \qquad Eq . 3$$

In this case, one may first identify the corresponding HLLs for A1, A2, and A3 respectively, so that the union of A1, A2, and A3 as well as the union of A2 and A3 can be obtained. Noticeably, traditional symbolic logic is not used here to transform the original expression to other forms for possible use of HLL; rather a Venn diagram provided an expedite process for transforming this expression to unions of HLL data structures. Advantageously, the transformed expression of |A1 OR A2 OR A3|−|A2 OR A3| does not implicate any other audience segments in the universe. Unlike in block 320 or 330, wherein the cardinality of the entire universe is necessary when the input expression as a whole is being negated, the negation of a partial Boolean expression here does not introduce the complexity associated with the cardinality of the entire universe anymore. Therefore, the computational complexity for the cardinality of this kind of ALEs is greatly reduced.

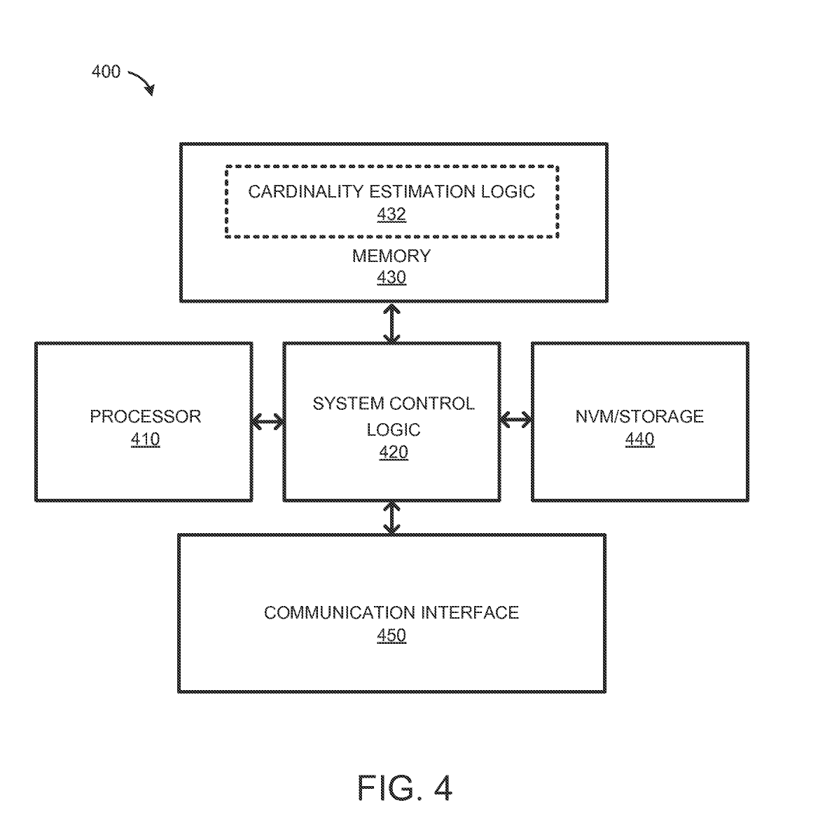

FIG. 4 illustrates an embodiment of a computing device 400 suitable for practicing embodiments of the present disclosure. Computing device 400 may be any computing device, e.g., in forms such as a smartphone, a wearable device, a tablet, a laptop, a desktop, a server, etc. As illustrated, computing device 400 includes system control logic 420 coupled to processor 410, to system memory 430, to non-volatile memory (NVM)/storage 440, and to communication interface 450. In various embodiments, processor 410 includes one or more processor cores.

In various embodiments, communication interface 450 provides an interface for computing device 400 to communicate with another computing device (e.g., a server device or a user device). In various embodiments, communication interface 450 provides an interface for computing device 400 to communicate over one or more network(s) and/or with any other suitable device. Communication interface 450 may include any suitable hardware and/or firmware, such as a network adapter, one or more antennas, wireless interface(s), and so forth. In various embodiments, communication interface 450 includes an interface for computing device 400 to use near field communication (NFC), optical communications, or other similar technologies to communicate directly (e.g., without an intermediary) with another device. In various embodiments, communication interface 450 may interoperate with radio communications technologies such as, for example, Wideband Code Division Multiple Access (WCDMA), Global System for Mobile Communications (GSM), Long Term Evolution (LTE), Bluetooth®, Zigbee, and the like.

In some embodiments, system control logic 420 may include any suitable interface controllers to provide for any suitable interface to the processor 410 and/or to any suitable device or component in communication with system control logic 420. System control logic 420 may also interoperate with a display (not shown) for display of information, such as to a user. In various embodiments, the display may include one of various display formats and forms, such as, for example, liquid-crystal displays, cathode-ray tube displays, e-ink displays, projection displays, etc. In some embodiments, the display includes a touch screen. In some embodiments, computing device 400 may operate without the display, e.g., when computing device 400 functions as a server device.

In some embodiments, system control logic 420 may include one or more memory controller(s) (not shown) to provide an interface to system memory 430. System memory 430 may be used to load and store data and/or instructions, for example, for computing device 400. System memory 430 may include any suitable volatile memory, such as dynamic random access memory (DRAM), for example.

In some embodiments, system control logic 420 may include one or more input/output (I/O) controller(s) (not shown) to provide an interface to NVM/storage 440 and communication interface 450. NVM/storage 440 can be used to store data and/or instructions, for example. NVM/storage 440 may include any suitable non-volatile memory, such as flash memory, for example, and/or may include any suitable non-volatile storage device(s), such as one or more hard disk drive(s) (HDD), one or more solid-state drive(s), one or more compact disc (CD) drive(s), and/or one or more digital versatile disc (DVD) drive(s), for example. NVM/storage 440 may include a storage resource that is physically part of a device on which computing device 400 is installed, or it may be accessible by, but not necessarily a part of, computing device 400. For example, NVM/storage 440 may be accessed by computing device 400 over a network via communication interface 450.

In various embodiments, system memory 430, NVM/storage 440, or system control logic 420 includes, in particular, temporal and persistent copies of cardinality estimation logic 432. Cardinality estimation logic 432 may include instructions that, when executed by processor 410, result in computing device 400 estimating cardinality, such as, but not limited to, process 200 and/or process 300. In various embodiments, cardinality estimation logic 432 includes instructions that, when executed by processor 410, result in computing device 400 performing various functions associated with, but not limited to, conversion module 114, estimation module 116, communication module 112, and Hyperloglog module 118, in connection with FIG. 1.

In some embodiments, processor 410 may be packaged together with system control logic 420 and/or cardinality estimation logic 432. In some embodiments, at least one of the processor(s) 410 may be packaged together with system control logic 420 and/or cardinality estimation logic 432 to form a System in Package (SiP). In some embodiments, processor 410 may be integrated on the same die with system control logic 420 and/or cardinality estimation logic 432. In some embodiments, processor 410 may be integrated on the same die with system control logic 420 and/or cardinality estimation logic 432 to form a System on Chip (SoC).

Depending on which modules of cardinality estimation server 110 in connection with FIG. 1 are hosted by computing device 400, the capabilities and/or performance characteristics of processor 410, system memory 430, and so forth, may vary. In various implementations, computing device 400 may be a smartphone, a tablet, a mobile computing device, a wearable computing device, a server, etc., enhanced with the teachings of the present disclosure.

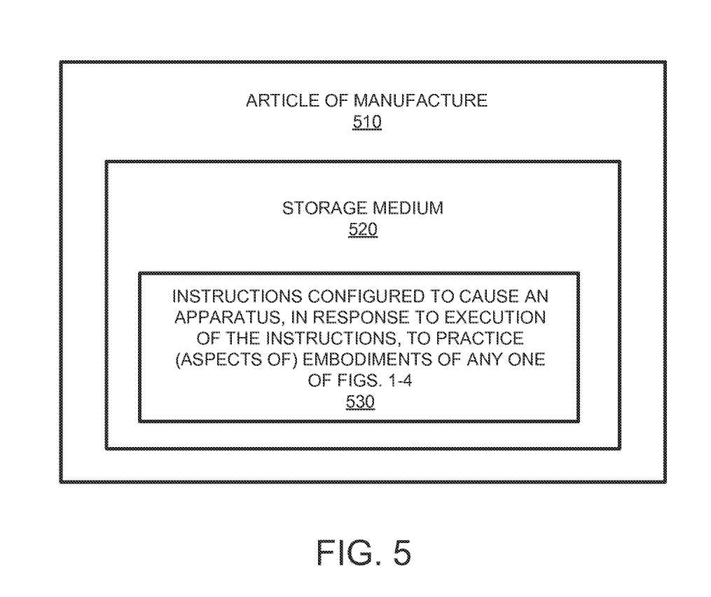

FIG. 5 illustrates an article of manufacture 510 having programming instructions, incorporating aspects of the present disclosure, in accordance with various embodiments. In various embodiments, an article of manufacture is to be employed to implement various embodiments of the present disclosure. As shown, the article of manufacture 510 includes a computer-readable non-transitory storage medium 520 where instructions 530 are configured to practice embodiments of or aspects of embodiments of any one of the processes described herein. The storage medium 520 represents a broad range of persistent storage media known in the art, including but not limited to flash memory, dynamic random access memory, static random access memory, an optical disk, a magnetic disk, etc. Instructions 530 enables an apparatus, in response to their execution by the apparatus, to perform various operations described herein. For example, storage medium 520 includes instructions 530 configured to cause an apparatus, e.g., cardinality estimation server 110 of FIG. 1, to practice some or all aspects of estimating cardinality, as illustrated in process 200 of FIG. 2, process 300 of FIG. 3, or aspects of embodiments of any one of the figures disclosed herein. In various embodiments, computer-readable storage medium 520 includes one or more computer-readable non-transitory storage media. In other embodiments, computer-readable storage medium 520 may be transitory, such as signals, encoded with instructions 530.

In the preceding detailed description, reference is made to the accompanying drawings, which form a part hereof, wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the detailed description is not to be taken in a limiting sense, and the scope of embodiments is defined by the appended claims and their equivalents.

Although the terms “step” and/or “block” may be used herein to connote different elements of methods employed, the terms should not be interpreted as implying any particular order among or between various steps herein disclosed unless and except when the order of individual steps is explicitly described. Further, various operations may be described as multiple discrete actions or operations in turn, in a manner that is most helpful in understanding the claimed subject matter. However, various additional operations may be performed, and/or described operations may be omitted or combined in other embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). Where the disclosure recites “a” or “a first” element or the equivalent thereof, such disclosure includes one or more such elements, neither requiring nor excluding two or more such elements. Further, ordinal indicators (e.g., first, second, or third) for identified elements are used to distinguish between the elements and do not indicate or imply a required or limited number of such elements, nor do they indicate a particular position or order of such elements unless otherwise specifically stated.

Reference in the description to one embodiment or an embodiment means that a particular feature, structure, or characteristic described in connection with the embodiment is included in at least one embodiment of the invention. The description may use the phrases “in one embodiment,” “in an embodiment,” “in another embodiment,” “in various embodiments,” or the like, which may each refer to one or more of the same or different embodiments. Furthermore, the terms “comprising,” “including,” “having,” and the like, as used with respect to embodiments of the present disclosure, are synonymous.

In various embodiments, the term “module” may refer to, be part of, or include an application specific integrated circuit (ASIC), an electronic circuit, a processor (shared, dedicated, or group), and/or memory (shared, dedicated, or group) that execute one or more software or firmware programs, a combinational logic circuit, and/or other suitable components that provide the described functionality. In various embodiments, a module may be implemented in firmware, hardware, software, or any combination of firmware, hardware, and software.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

The subject matter of the present invention is described with specificity herein to meet statutory requirements. However, the description itself is not intended to limit the scope of this patent. Rather, the inventors have contemplated that the claimed subject matter might also be embodied in other ways, to include different components, modules, blocks, steps, etc., similar to the ones described in this document, in conjunction with other present or future technologies.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

What is claimed is:

1. An apparatus for determining cardinalities of audience segments, comprising:
a communication module to receive a query for a cardinality associated with an audience logical expression in order to determine a number of individuals in an audience segment associated with the audience logical expression;
a conversion module, coupled to the networking module, to identify, based on the audience logical expression, a plurality of components with each component represented by a Hyperloglog data structure or a union of Hyperloglog data structures; and
an estimation module, coupled to the conversion module, to estimate respective cardinality associated with respective components of the plurality of components from respective Hyperloglog data structures or union of Hyperloglog data structures, and to determine the cardinality associated with the audience logical expression based on one or more addition or subtraction operations with the respective cardinality associated with respective components of the plurality of components.

2. The apparatus of claim 1, wherein the communication module is further to receive the audience logical expression having audience segments for a given time period with at least one selected operator from conjunction, disjunction, and negation.

3. The apparatus of claim 1, wherein the conversion module is further to identify the plurality of components corresponding to the audience logical expression including a negation of a plurality of disjunctive expressions.

4. The apparatus of claim 1, wherein the conversion module is further to identify the plurality of components corresponding to the audience logical expression including an intersection of two disjunctive expressions.

5. The apparatus of claim 1, wherein the conversion module is further to identify the plurality of components corresponding to the audience logical expression including an intersection of two disjunctive expressions wherein exactly one of the two disjunctive expressions has a negation.

6. The apparatus of claim 1, wherein the conversion module is further to identify the plurality of components corresponding to the audience logical expression including a conjunction operator.

7. The apparatus of claim 1, wherein the conversion module is further to identify a term associated with a negation operator in the audience logical expression; estimate a cardinality associated with a union of all Hyperloglog data structures and a cardinality associated with the term; and subtract the cardinality associated with the term from the cardinality associated with the union of all Hyperloglog data structures.

8. The apparatus of claim 1, wherein the estimation module is further to find respective Hyperloglog value of respective Hyperloglog data structures or union of Hyperloglog data structures.

9. A computer-implemented method for determining cardinalities of audience segments, comprising:
receiving a query for a cardinality associated with a Boolean expression;
identifying based on the Boolean expression, a plurality of components with each component represented by a Hyperloglog data structure or a union of Hyperloglog data structures;
estimating respective cardinality associated with respective components of the plurality of components, based on respective Hyperloglog data structures or union of Hyperloglog data structures; and
determining the cardinality associated with the Boolean expression based on one or more addition or subtraction operations with the respective cardinality associated with respective components of the plurality of components.

10. The method of claim 9, wherein the receiving comprises receiving the Boolean expression over audience segments with at least one selected operator from conjunction, disjunction, and negation.

11. The method of claim 9, wherein the identifying comprises identifying the plurality of components corresponding to the Boolean expression including a negation of a plurality of disjunctive expressions.

12. The method of claim 9, wherein the identifying comprises identifying the plurality of components corresponding to the Boolean expression including an intersection of two disjunctive expressions.

13. The method of claim 9, wherein the identifying comprises identifying the plurality of components corresponding to the Boolean expression including an intersection of two disjunctive expressions wherein exactly one of the two disjunctive expressions has a negation.

14. The method of claim 9, wherein the identifying comprises identifying a component with a union of two terms from the Boolean expression in response to a conjunction operator between the two terms in the Boolean expression.

15. The method of claim 9, wherein the identifying comprises identifying at least one of the plurality of components based on an inclusion-exclusion principle applied on the Boolean expression with at least one conjunction operator.

16. The method of claim 9, wherein the identifying comprises identifying a term associated with a negation operator in the Boolean expression; and wherein estimating comprises estimating a cardinality associated with a union of all Hyperloglog data structures and a cardinality associated with the term.

17. The method of claim 9, wherein the estimating comprises finding respective Hyperloglog value of respective Hyperloglog data structures or union of Hyperloglog data structures.

18. One or more non-transient computer storage media storing computer-readable instructions that, when executed by one or more processors of a computer system, cause the computer system to perform operations comprising:
receiving a query for a cardinality associated with an audience logical expression having one or more audience segments;
identifying, based on the audience logical expression, a plurality of components with each component represented by a Hyperloglog data structure or a union of Hyperloglog data structures;
estimating respective cardinality associated with respective components of the plurality of components, based on respective Hyperloglog data structures or union of Hyperloglog data structures; and
determining the cardinality associated with the audience logical expression based on one or more addition or subtraction operations with the respective cardinality associated with respective components of the plurality of components.

19. The storage media of claim 18, wherein the instructions further cause the one or more computing devices to perform operations comprising:
identifying the plurality of components corresponding to the audience logical expression including a negation of a plurality of disjunctive expressions;
identifying a component with a union of two terms from the audience logical expression in response to a conjunction operator between the two terms in the audience logical expression; r
identifying the plurality of components corresponding to the audience logical expression including an intersection of two disjunctive expressions wherein exactly one of the two disjunctive expressions has a negation;

20. The storage media of claim 18, wherein the instructions further cause the one or more computing devices to perform operations comprising:
identifying a term associated with a negation operator in the audience logical expression;
estimating a cardinality associated with a union of all Hyperloglog data structures and a cardinality associated with the term; and
subtracting the cardinality associated with the term from the cardinality associated with the union of all Hyperloglog data structures.
